(19) United States
(12) Patent Application Publication
(10) Pub. No.: US 2023/0238666 A1
(43) Pub. Date: Jul. 27, 2023

(54) ELECTROCHEMICAL DEVICE AND ELECTRONIC DEVICE

(71) Applicant: Ningde Amperex Technology Limited, Ningde (CN)

(72) Inventor: Deyu FANG, Ningde (CN)

(73) Assignee: Ningde Amperex Technology Limited, Ningde (CN)

(21) Appl. No.: 18/192,238

(22) Filed: Mar. 29, 2023

Related U.S. Application Data
(63) Continuation of application No. PCT/CN2021/084689, filed on Mar. 31, 2021.

(51) Int. Cl. H01M 50/538; H01M 50/534; H01M 10/04; H01M 4/62

(52) U.S. Cl. CPC H01M 50/538; H01M 50/534; H01M 10/0431; H01M 4/625

(57) ABSTRACT

An electronic device includes an electrode assembly. The electrode assembly is configured to be a wound structure and is provided with a first bending section. The electrode assembly comprises a first electrode plate, a second electrode plate, and a conductive member. The first electrode plate includes a first current collector and a first active material layer, and along a winding direction, the first current collector includes a first part and a second part that are connected in sequence. Both surfaces of the first part are arranged with the first active material layer, an inner surface of the second part is provided with the first active material layer, and the second part includes a bending part located at an outermost layer of the first bending section. The conductive member connects the outer surfaces of the first part and the second part, and/or covers on the outer surface of the bending part.

### CROSS-REFERENCE TO RELATED APPLICATION

The present application is a continuation application of PCT Application Serial No. PCT/CN2021/084689, filed on Mar. 31, 2021, the content of which is incorporated by reference in its entirety.

### FIELD

The present application relates to the battery technology field, and in particular to an electrochemical device and an electronic device.

### BACKGROUND

In order to pursue higher volumetric energy density, a current collector (copper foil or aluminum foil) used in consumer electrochemical devices is continuously thinned, the coating weight per unit area is continuously increased, and the repeated expansion in a charge and discharge process finally leads to a fracture of current collector of a battery with a wound structure at an uneven stress position such as bending section or junction of single-sided and double-sided. On the one hand, the fracture of the current collector may reduce the battery capacity and reduce the experience of consumers. On the other hand, there may be burrs in the current collector at the fracture, which has a potential risk of short circuit.

### SUMMARY

In view of the above situation, it is necessary to provide an electrochemical device and an electronic device, so as to improve the problem of a fracture of current collector.

An embodiment of the present application provides an electrochemical device including an electrode assembly, the electrode assembly is configured to be a wound structure. The electrode assembly is provided with a first bending section, and comprises a first electrode plate, a second electrode plate, and a conductive member. The first electrode plate includes a first current collector and a first active material layer arranged on the first current collector, and along a winding direction, the first current collector includes a first part and a second part that are connected in sequence. Both surfaces of the first part are arranged with the first active material layer, an inner surface of the second part is provided with the first active material layer, and the second part includes a bending part located at an outermost layer of the first bending section. The conductive member connects and an outer surface of the second part and the first active material layer arranged on an outer surface of the first part, and/or is arranged on an outer surface of the bending part.

The above-mentioned electrochemical device connects the outer surfaces of the first part and the second part and/or covers the outer surface of the bending part of the second part through the conductive member, so as to cover a region prone to a fracture of current collector. After the current collector fractures, the conductive member can electrically connect the electrode plate at the fracture of the current collector, which reduces a capacity loss of the electrochemical device due to the fracture of the current collector or a risk of short circuit caused by the fracture of the current collector, and in addition, the conductive member has a simple and reliable structure and low cost.

In some embodiments of the present application, the electrode assembly further comprises a first adhesive member, the first adhesive member adheres the conductive member and the first electrode plate. The first adhesive member can stably connect the conductive member to the first electrode plate.

In some embodiments of the present application, the conductive member includes a metal sheet or a conductive tape. In some embodiments of the present application, the conductive tape includes a substrate layer and a conductive layer; the substrate layer and the conductive layer are laminated. In some embodiments of the present application, the conductive layer includes conductive particles and an adhesive material.

In some embodiments of the present application, the conductive tape further includes an adhesive layer, the adhesive layer is arranged between the substrate layer and the conductive layer; or, the adhesive layer is arranged on a surface of the substrate layer, and the conductive layer is arranged on the surface of the substrate layer on a same side as the adhesive layer.

In some embodiments of the present application, the second part includes a connecting part connected with the first part, and the conductive member is connected with an outer surface of the connecting part.

In some embodiments of the present application, an outer surface of the second part exposes the first current collector. In some embodiments of the present application, the first electrode plate is a negative electrode plate, and an outer surface of the bending part is provided with the first active material layer.

In some embodiments of the present application, the second part is a tail part of the electrode assembly along the winding direction. In some embodiments of the present application, the conductive member includes a first conductive member and a second conductive member, the first conductive member connects the outer surface of the second part and the first active material layer arranged on the outer surface of the first part, and the second conductive member is arranged on the outer surface of the bending part.

In some embodiments of the present application, the first conductive member is connected with the second conductive member. In some embodiments of the present application, the electrode assembly is further provided with a first section, a second bending section and a second section, and along the winding direction, the first bending section, the first section, the second bending section and the second section are connected in sequence, and the connecting part is located in the first section.

In some embodiments of the present application, the electrode assembly further includes a metal part, and along the winding direction, the second part further includes a tail part, and the metal part is connected with the tail part. In some embodiments of the present application, both surfaces of the tail part expose the first current collector.

In some embodiments of the present application, the electrode assembly further comprises a second electrode plate and a separator arranged between the first electrode plate and the second electrode plate, and the first electrode plate, the second electrode plate and the separator are laminated in sequence and wound.

In some embodiments of the present application, the substrate layer includes at least one selected from the group consisting of cellulose derivative, polyvinyl chloride, polyolefin, polystyrene, polyester, polyimide, polyamide, polycarbonate and polyphenylene sulfide. In some embodiments of the present application, the adhesive material includes at least one selected from the group consisting of rubber resin, acrylic resin and silicone resin; the conductive particles include at least one selected from the group consisting of metal particles, conductive polymers and carbon materials; the conductive polymer includes at least one selected from the group consisting of polythiophene, polyaniline, polypyrrole and polyacetylene; the carbon material includes at least one selected from the group consisting of carbon black, acetylene black, Ketjen black, graphite, graphene, carbon nanotubes and carbon nanorods.

An embodiment of the present application further provides an electronic device, which comprises the above-mentioned electrochemical device. The electrochemical device can provide electrical energy for the electronic device.

### BRIEF DESCRIPTION OF THE DRAWINGS

FIG. 1 is a sectional view of an electrode assembly in an embodiment of the present application.

FIG. 2 is an enlarged view of a position region of a connecting part in an embodiment of the present application.

FIG. 3 is another view of a position region of the connecting part in another embodiment of the present application.

FIG. 4 is an enlarged view of a position region of the connecting part in another embodiment of the present application.

FIG. 5 is a plan view of a first conductive member in another embodiment of the present application.

FIG. 6 is a plan view of a first conductive member in another embodiment of the present application.

FIG. 7 is a sectional view of a first conductive member in another embodiment of the present application.

FIG. 8 is an enlarged view of the position region of the connecting part in another embodiment of the present application.

FIG. 9 is an enlarged view of the position region of the connecting part in another embodiment of the present application.

FIG. 10 is a sectional view of an electrode assembly in another embodiment of the present application.

FIG. 11 is a sectional view of an electrode assembly in another embodiment of the present application.

FIG. 12 is a sectional view of an electrode assembly in another embodiment of the present application.

FIG. 13 is a sectional view of an electrode assembly in another embodiment of the present application.

FIG. 14 is a sectional view of an electrode assembly in another embodiment of the present application.

FIG. 15 is a sectional view of an electrode assembly in another embodiment of the present application.

FIG. 16 is a sectional view of an electrode assembly in another embodiment of the present application.

### REFERENCE NUMERALS OF MAIN ELEMENTS

| | |
|---|---|
| Electrode assembly | 100 |
| First bending section | 1 |
| First section | 2 |
| Second bending section | 3 |
| Second section | 4 |
| First electrode plate | 5 |
| First current collector | 51 |
| First part | 511 |
| First outer surface | 5111 |
| First inner surface | 5112 |
| Second part | 512 |
| Connecting part | 5121 |
| First bending part | 5122 |
| Second bending part | 5123 |
| Second outer surface | 5124 |
| Second inner surface | 5125 |
| First active material layer | 52 |
| First starting part | 53 |
| First ending part | 54 |
| Second electrode plate | 6 |
| Second current collector | 61 |
| Second active material layer | 62 |
| Second starting part | 63 |
| Second ending part | 64 |
| Separator | 7 |
| First conductive member | 81 |
| Substrate layer | 811 |
| Conductive layer | 812 |
| Adhesive layer | 813 |
| Second conductive member | 82 |
| Third conductive member | 83 |
| First adhesive member | 84 |
| Second adhesive member | 85 |
| Third adhesive member | 86 |
| First metal part | 91 |
| Second metal part | 92 |
| Winding center | 200 |
| Winding direction | X |
| Thickness direction | Y |

The following specific embodiments will further describe the present application in combination with the above drawings.

### DETAILED DESCRIPTION

Hereinafter, the technical solutions in the embodiments of the present application will be described in combination with the drawings in the embodiment of the present application. It goes without saying that the described embodiments are a part of the embodiments of the present application, not all of the embodiments.

It should be noted that when an element is considered to “connect” another element, it may be directly connected to another element or there are other elements arranged between them at the same time. When an element is considered to be “arranged” on another element, it may be an element arranged directly on another element or there are other elements arranged between them at the same time.

Unless otherwise defined, all technical and scientific terms used herein have the same meanings as those commonly understood by those skilled in the art of the present application. The terms used in the description of the present application herein are only for the purpose of describing specific embodiments and are not intended to limit the present application. The term “and/or” as used herein includes any and all combinations of one or more related listed items.

An embodiment of the present application provides an electrochemical device and an electronic device, and the electronic device includes the electrochemical device. The electrochemical device includes an electrode assembly, and the electrode assembly is configured to be a wound structure. The electrode assembly comprises a first electrode plate, a second electrode plate, and a conductive member. The electrode assembly is provided with a first bending section. The first electrode plate includes a first current collector and a first active material layer arranged on the first current collector, and along a winding direction, the first current collector includes a first part and a second part that are connected in sequence. Both surfaces of the first part are arranged with the first active material layer, an inner surface of the second part is provided with the first active material layer, and the second part includes a bending part located at an outermost layer of the first bending section. The conductive member connects the outer surface of the second part and the first active material layer arranged on the outer surface of the first part, and/or is arranged on the outer surface of the bending part. The above-mentioned electrochemical device connects the outer surfaces of the first part and the second part and/or covers the outer surface of the bending part of the second part through the conductive member, so as to cover a region prone to a fracture of current collector with the conductive member. After the current collector fractures, the conductive member can electrically connect the electrode plate at the fracture of the current collector, which reduces a capacity loss of the electrochemical device due to the fracture of the current collector or a risk of short circuit caused by the fracture of the current collector, and in addition, the conductive member has a simple and reliable structure and low cost.

The electrochemical device can provide electric energy for the electronic device.

Hereinafter, an embodiment of the present application will be further described in combination with the accompanying drawings.

The present disclosure provides an electrochemical device for supplying electric energy to an electronic device. The electrochemical device includes an electrode assembly.

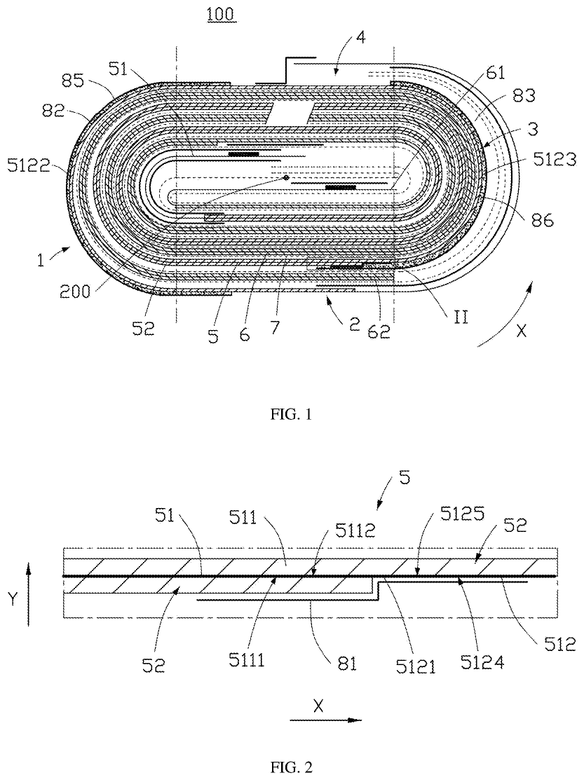

As shown in FIG. 1, the electrode assembly 100 includes a first electrode plate 5, a second electrode plate 6 and a separator 7. The separator 7 is arranged between the first electrode plate 5 and the second electrode plate 6, and the first electrode plate 5, the second electrode plate 6 and the separator 7 are laminated in sequence and wound along a winding direction X to form a wound structure.

The first electrode plate 5 includes a first current collector 51 and a first active material layer 52 arranged on the first current collector 51. The second electrode plate 6 includes a second current collector 61 and a second active material layer 62 arranged on the second current collector 61.

In some embodiments, the first electrode plate 5 may be a cathode electrode plate, and the first current collector 51 may be made of metal materials such as aluminum foil. The second electrode plate 6 may be an anode electrode plate, and the second current collector 61 may be made of copper foil material. In some embodiments, the first electrode plate 5 may be an anode electrode plate and the second electrode plate 6 may be a cathode electrode plate.

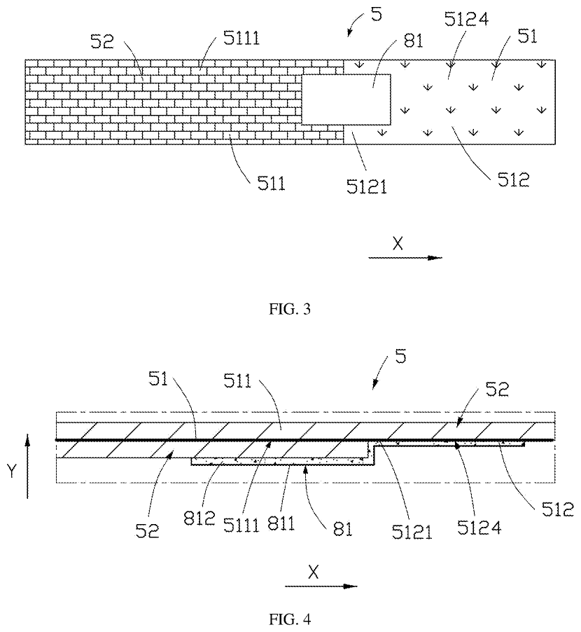

As shown in FIGS. 1, 2 and 3, the first current collector 51 includes a first part 511 and a second part 512. In a wound state, the first part 511 and the second part 512 are connected in sequence along the winding direction X.

In a thickness direction Y of the first electrode plate 5, both sides of the first part 511 include a first outer surface 5111 and a first inner surface 5112, respectively. Both the first outer surface 5111 and the first inner surface 5112 are arranged with the first active material layer 52, and the first outer surface 5111 is located on a side of the first part 511 deviated from a winding center. In some embodiments, the thickness direction Y of the first electrode plate 5 is consistent with that of the electrode assembly 100.

In some embodiments, the first outer surface 5111 of the first part 511 exposes the first current collector 51.

In the thickness direction of the first electrode plate 5, both sides of the second part 512 include a second outer surface 5124 and a second inner surface 5125 respectively. The second inner surface 5125 is provided with a first active material layer 52, and the second outer surface 5124 is located on a side of the second part 512 deviated from the winding center.

In some embodiments, the second outer surface 5124 on the second part 512 exposes the first current collector 51.

In some embodiments, the second outer surface 5124 of the second part 512 may be partially provided with a first active substance layer 52. In some embodiments, the second outer surface 5124 of the second part 512 may be provided with no first active material layer 52.

In some embodiments, the first inner surface 5112 of the first part 511 is connected with the second inner surface 5125 of the second part 512 in sequence along the winding direction X.

In some embodiments, the first outer surface 5111 of the first part 511 is connected with the second outer surface 5124 of the second part 512 in sequence along the winding direction X.

In the present application, the winding center refers to a center of the innermost layer where the electrode assembly 100 starts winding. In some embodiments, the electrode assembly 100 is wound from the separator 7, and the winding center is a winding center 200 of the separator 7.

In the present application, an inner surface refers to a position towards the winding center, and an outer surface refers to a position deviated from the winding center.

A connecting part 5121 is arranged at a position where the first portion 511 is connected with the second portion 512. It can be understood that the first part 511 and the second part 512 are connected in sequence along the winding direction X, and the connecting part 5121 may be a part of the second part 512 connected with the first part 511.

In some embodiments, the second outer surface 5124 of the second part 512 is provided with no first active material layer 52, or is provided with the first active material layer 52, but the thickness of the first active material layer 52 on both sides of the second part 512 along the thickness direction of the first electrode plate 5 is less than that of the first active material layer 52 on both sides of the first part 511, which may lead to stress concentration in a position region of the connecting part 5121 during stress, which may easily lead to the fracture of the first current collector 51 in this region, further resulting in a capacity loss of the electrochemical device or generation of burr which has a risk of short circuit.

Therefore, in order to avoid a problem of a fracture of the first current collector 51 or short circuit after the fracture, the electrode assembly 100 further includes a first conductive member 81, and the first conductive member 81 connects the first outer surface 5111 of the first part 511 and the second outer surface 5124 of the second part 512. When the first part 511 and the second part 512 fracture, the first conductive member 81 can continue to connect the first part 511 and the second part 512, so that the first part 511 and the second part 512 can continue to maintain electrical connection.

In some embodiments, the first conductive member 81 connects the outer surface of the connecting part 5121.

In some embodiments, the first conductive member 81 may be a conductive tape.

In some embodiments, the first conductive member 81 may be a metal foil such as aluminum foil, silver foil, gold foil, etc., or an alloy foil.

In some embodiments, as shown in FIG. 4, when the first conductive member 81 is a conductive tape, the conductive tape may include a substrate layer 811 and a conductive layer 812; the substrate layer 811 and the conductive layer 812 are laminated.

In some embodiments, the conductive layer 812 may include conductive particles, the conductive layer 812 connects the second outer surface 5124 and the first active material layer 52 arranged on the first outer surface 5111, and the conductive particles can electrically connect the first current collector 51 of the first part 511 with the first current collector 51 exposed from the second outer surface 5124.

In order for the conductive layer 812 to stably connect the first electrode plate 5, in some embodiments, the conductive layer further includes an adhesive material.

In some embodiments, the conductive tape further includes an adhesive layer 813.

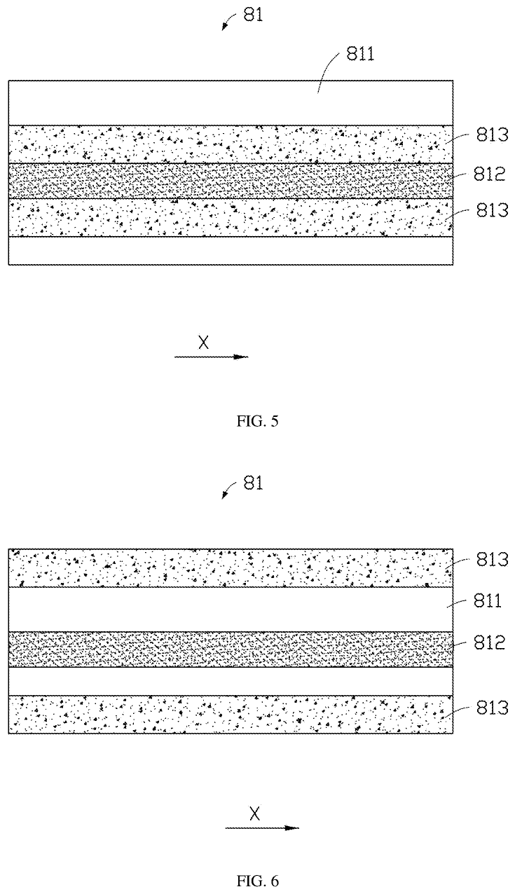

As shown in FIGS. 5 and 6, the adhesive layer 813 may be arranged on a surface of the substrate layer 811 which is on the same side as the conductive layer 812.

In some embodiments, the adhesive layer 813 and the conductive layer 812 may be arranged in a staggered manner along a direction perpendicular to the winding direction X.

In some embodiments, the adhesive layer 813 may be arranged at an edge of the substrate layer 811, and the conductive layer 812 may be arranged at a middle position of the surface of the substrate layer 811 by extending along the winding direction X.

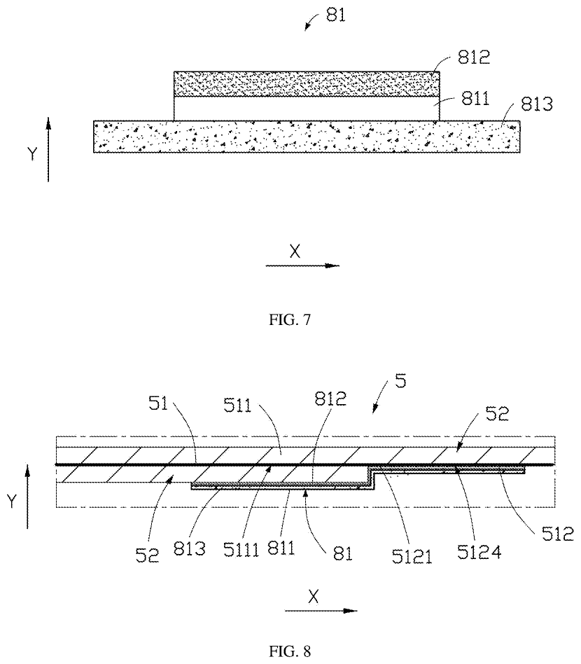

In some embodiments, as shown in FIG. 7, the adhesive layer 813 may also be arranged on a side of the substrate layer 811 deviated from the conductive layer 812. When viewed along the thickness direction of the conductive tape, a part of the adhesive layer 813 is adhered to the substrate layer 811, and the other part of the adhesive layer 813 is located outside the substrate layer 811 for adhering the first electrode plate 5, so that the conductive layer 812 can be adhered to the first electrode plate 5. In some embodiments, the thickness direction Y of the first electrode plate 5 is consistent with that of the conductive tape.

In some embodiments, the substrate layer includes at least one selected from the group consisting of cellulose derivative, polyvinyl chloride, polyolefin, polystyrene, polyester, polyimide, polyamide, polycarbonate, and polyphenylene sulfide.

In some embodiments, the adhesive material includes at least one selected from the group consisting of rubber-based resin, acrylic-based resin, and silicone-based resin. In some embodiments, the conductive particles include at least one selected from the group consisting of metal particles, conductive polymers, and carbon materials.

In some embodiments, the conductive polymer includes at least one selected from the group consisting of polythiophene, polyaniline, polypyrrole and polyacetylene.

In some embodiments, the carbon material includes at least one selected from the group consisting of carbon black, acetylene black, Ketjen black, graphite, graphene, carbon nanotubes and carbon nanorods.

As shown in FIG. 8, in some embodiments, the adhesive layer 813 may also be arranged between the substrate layer 811 and the conductive layer 812.

As shown in FIG. 9, in some embodiments, the first conductive member 81 may be a metal sheet. In order to ensure the reliability of the metal sheet to connect the first electrode plate 5, the electrode assembly 100 further includes a first adhesive member 84, and the first adhesive member 84 adheres the first conductive member 81 and the first electrode plate 5.

In some embodiments, the first adhesive member 84 may be arranged on a side of the first conductive member 81 deviated from the first electrode plate 5. At this time, when viewed along the thickness direction of the first conductive member 81, one part of the first adhesive member 84 is adhered to the first conductive member 81, and the other part of the first adhesive member 84 is adhered to the first electrode plate 5. In some embodiments, the thickness direction Y of the first electrode plate 5 is consistent with that of the first conductive member 81.

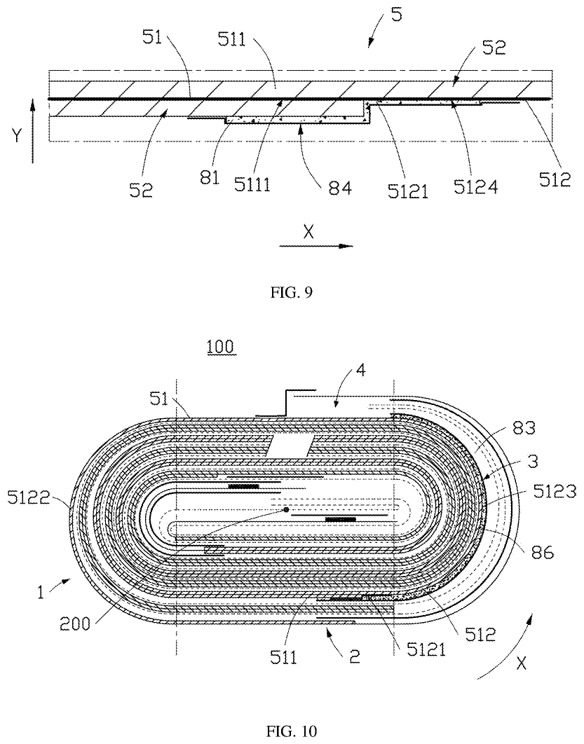

As shown in FIGS. 1 and 10, when the electrode assembly 100 expands, the first electrode plate 5 is subjected to tension, which may lead to a fracture of the first current collector 51 in a region of the connecting part 5121 prone to stress concentration. When the first current collector 51 in this region fractures, the first conductive member 81 can electrically reconnect the first collector 51 on both sides of the crack, so as to prevent burr caused by fracture from leading to short circuit.

The electrode assembly 100 is configured to be a wound structure so that the electrode assembly 100 includes a first bending section 1, a first section 2, a second bending section 3 and a second section 4 that are connected in sequence. The connecting part 5121 is located on the first section 2.

The second part 512 includes a first bending part 5122 on the first bending section 1 and a second bending part 5123 on the second bending section 3.

Due to the influence of bending, the first current collector 51 on the first bending part 5122 and/or the second bending part 5123 is subject to tension and is prone to fracture when stressed. If the first current collector 51 on the first bending part 5122 and/or the second bending part 5123 fractures, the capacity of the electrochemical device will be lost or burrs will be generated, so that there is a risk of short circuit.

In order to avoid the problem of a fracture of the first current collector 51 on the first bending part 5122 and/or the second bending part 5123 or short circuit after the fracture, the electrode assembly 100 further includes a second conductive member 82 and a third conductive member 83, the second conductive member 82 is coated on an outer surface of the first bending part 5122, and the third conductive member 83 is coated on an outer surface of the second bending part 5123.

The material and composition of the second conductive member 82 and the third conductive member 83 may be the same as that of the first conductive member 81, which will not be repeated herein.

In order to ensure the reliability of the second conductive member 82 and the third conductive member 83 to connect the first electrode plate 5, the electrode assembly 100 further includes a second adhesive member 85 and a third adhesive member 86, the second adhesive member 85 adheres the second conductive member 82 and the first electrode plate 5, and the third adhesive member 86 adheres the third conductive member 83 and the first electrode plate 5.

The material and composition of the second adhesive member 85 and the third adhesive member 86 may be the same as that of the first adhesive member 84, which will not be repeated herein.

In order to prevent the fracture of the first current collector 51 on the first bending part 5122 from adversely affecting the electrochemical device, the second conductive part 82 can be completely coated on an outer surface of the first bending part 5122, that is, along the winding direction X, the second conductive part 82 covers the first bending part 5122, and both ends connects the first section 2 and the second section 4.

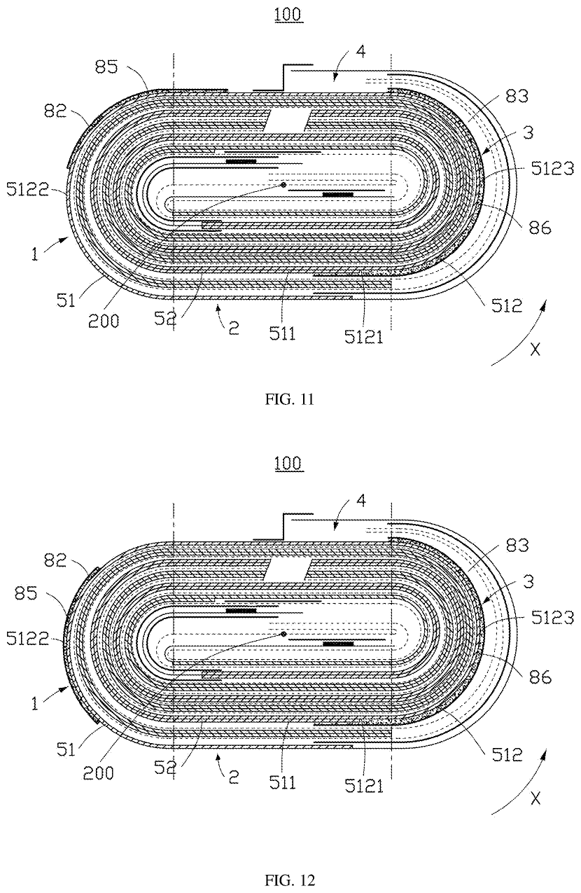

As shown in FIGS. 11 and 12, in some embodiments, the second conductive member 82 can cover only a region on the first bending section 5122 where the first collector 51 is prone to fracture, such as the first bending section 5122 at a connecting inflection point of the first bending section 1 and the first section 2 and/or the second section 4, or the first bending section 5122 on the first bending section 1.

In order to prevent the fracture of the first current collector 51 on the second bending part 5123 from adversely affecting the electrochemical device, the third conductive member 83 can be completely coated on an outer surface of the second bending part 5123, that is, along the winding direction X, the third conductive member 83 covers the second bending part 5123, and both ends connect the first section 2 and the second section 4. At this time, if an end portion of the third conductive member 83 connecting the first section 2 is connected to the first active material layer arranged on the first outer surface 5111, the first conductive member 81 can be omitted and the third conductive member 83 can be connected to an outer surface of the connecting portion 5121, which can save the cost.

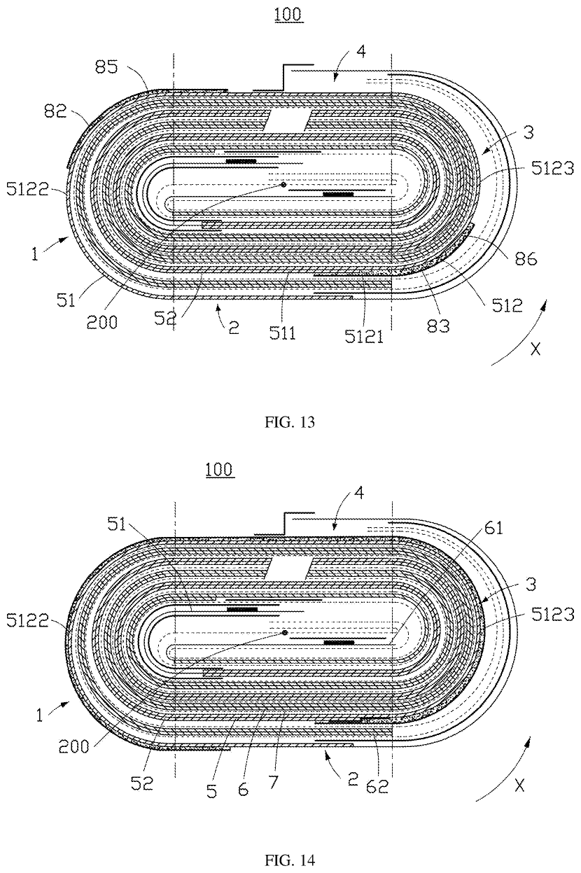

As shown in FIG. 13, in some embodiments, the third conductive member 83 can cover only a region on the second bending part 5123 where the first collector 51 is prone to fracture, such as the second bending part 5123 at a connecting inflection point of the second bending section 3 and the first section 2 and/or the second section 4. In some embodiments, any two of the first conductive member 81, the second conductive member 82 and the third conductive member 83 may be connected to each other.

As shown in FIG. 14, in some embodiments, the first conductive member 81, the second conductive member 82 and the third conductive member 83 may be connected together.

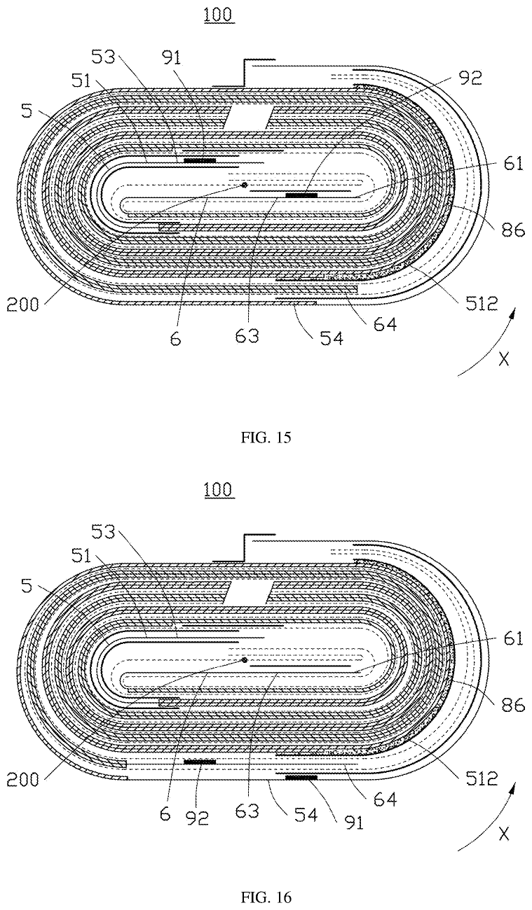

As shown in FIGS. 15 and 16, the electrode assembly 100 further includes a first metal portion 91 and a second metal portion 92.

The first electrode plate 5 includes a first starting part 53 and a first ending part 54. The first starting part 53 is close to a winding starting end of the first electrode plate 5, and the first ending part 54 is close to the winding tail end of the first electrode plate 5 and located on the second part 512.

The second electrode plate 6 includes a second starting part 63 and a second ending part 64. The second starting part 63 is close to the winding starting end of the second electrode plate 6, and the second end part 64 is close to the winding tail end of the second electrode plate 6.

The first metal part 91 and the second metal part 92 may be electrically connected to the first starting part 53 and the second starting part 63, respectively, or to the first ending part 54 and the second ending part 64, respectively, so that the electrochemical device can transmit electric energy to power an external device.

In summary, the electrochemical device connects the outer surfaces of the first part 511 and the second part 512 and/or covers the outer surface of the bending part of the second part 512 through the conductive part, so that the conductive part covers a region prone to a fracture of the current collector. After the current collector fractures, the conductive member can electrically connect the electrode plate at the fracture of the current collector, which reduces a capacity loss of the electrochemical device due to the fracture of the current collector or a risk of short circuit caused by the fracture of the current collector. Meanwhile, the conductive member has a simple and reliable structure and low cost.

In addition, those skilled in the art can also make other changes within the spirit of the present application. It goes without saying that these changes based on the present application should be included in the scope disclosed in the present application.

What is claimed is:

1. An electrochemical device, comprising an electrode assembly, the electrode assembly being configured to be a wound structure, and the electrode assembly being provided with a first bending section;
wherein the electrode assembly comprises:
a first electrode plate including a first current collector and a first active material layer arranged on the first current collector; wherein along a winding direction, the first current collector includes a first part and a second part connected in sequence, both surfaces of the first part are arranged with the first active material layer, an inner surface of the second part is provided with the first active material layer, and the second part includes a bending part located at an outermost layer of the first bending section; and
a conductive member connecting an outer surface of the second part and the first active material layer arranged on an outer surface of the first part, and/or being arranged on an outer surface of the bending part.

2. The electrochemical device according to claim 1, wherein the electrode assembly further comprises a first adhesive member, and the first adhesive member adheres the conductive member and the first electrode plate.

3. The electrochemical device according to claim 1, wherein the conductive member comprises a metal sheet or a conductive tape.

4. The electrochemical device according to claim 3, wherein the conductive tape comprises a substrate layer and a conductive layer; the substrate layer and the conductive layer are laminated.

5. The electrochemical device according to claim 4, wherein the conductive layer comprises conductive particles and an adhesive material.

6. The electrochemical device according to claim 4, wherein the conductive tape further comprises an adhesive layer,
the adhesive layer is arranged between the substrate layer and the conductive layer; or
the adhesive layer is arranged on a surface of the substrate layer, and the conductive layer is arranged on the surface of the substrate layer on a same side as the adhesive layer.

7. The electrochemical device according to claim 1, wherein the second part comprises a connecting part connected with the first part, and the conductive member is connected with an outer surface of the connecting part.

8. The electrochemical device according to claim 1, wherein the outer surface of the second part exposes the first current collector.

9. The electrochemical device according to claim 1, wherein the first electrode plate is a negative electrode plate, and the outer surface of the bending part is provided with the first active material layer.

10. The electrochemical device according to claim 1, wherein the second part is a tail part of the electrode assembly along the winding direction.

11. The electrochemical device according to claim 1, wherein the conductive member comprises a first conductive member and a second conductive member, the first conductive member connects the outer surface of the second part and the first active material layer arranged on the outer surface of the first part, and the second conductive member is arranged on the outer surface of the bending part.

12. The electrochemical device according to claim 11, wherein the first conductive member is connected with the second conductive member.

13. The electrochemical device according to claim 7, wherein the electrode assembly is further provided with a first section, a second bending section and a second section, and along the winding direction, the first bending section, the first section, the second bending section and the second section are connected in sequence, and the connecting part is located in the first section.

14. The electrochemical device according to claim 1, wherein the electrode assembly further comprises a metal part, and along the winding direction, the second part further includes a tail part, and the metal part is connected with the tail part.

15. The electrochemical device according to claim 14, wherein both surfaces of the tail part expose the first current collector.

16. The electrochemical device according to claim 1, wherein the electrode assembly further comprises a second electrode plate and a separator arranged between the first electrode plate and the second electrode plate; and the first electrode plate, the second electrode plate and the separator are laminated in sequence and wound.

17. The electrochemical device according to claim 4, wherein the substrate layer comprises at least one selected from the group consisting of cellulose derivative, polyvinyl chloride, polyolefin, polystyrene, polyester, polyimide, polyamide, polycarbonate and polyphenylene sulfide.

18. The electrochemical device according to claim 5, wherein
the adhesive material comprises at least one selected from the group consisting of rubber resin, acrylic resin and silicone resin;
the conductive particles comprise at least one selected from the group consisting of metal particles, conductive polymers and carbon materials;
the conductive polymer comprises at least one selected from the group consisting of polythiophene, polyaniline, polypyrrole and polyacetylene;
the carbon material comprises at least one selected from the group consisting of carbon black, acetylene black, Ketjen black, graphite, graphene, carbon nanotubes and carbon nanorods.

19. The electrochemical device according to claim 13, wherein the first section is a flat section.

20. An electronic device, comprising an electrochemical device; wherein the electrochemical device comprises an electrode assembly, the electrode assembly is configured to be a wound structure, and the electrode assembly is provided with a first bending section;
wherein the electrode assembly comprises:
a first electrode plate including a first current collector and a first active material layer arranged on the first current collector; wherein along a winding direction, the first current collector includes a first part and a second part connected in sequence, both surfaces of the first part are arranged with the first active material layer, an inner surface of the second part is provided with the first active material layer, and the second part includes a bending part located at an outermost layer of the first bending section; and
a conductive member connecting an outer surface of the second part and the first active material layer arranged on an outer surface of the first part, and/or being arranged on an outer surface of the bending part.
